(19) United States
(12) Patent Application Publication
(10) Pub. No.: US 2024/0200822 A1
(43) Pub. Date: Jun. 20, 2024

(54) VENTILATION SYSTEM

(71) Applicant: Innergy tech Inc., Drummondville (CA)

(72) Inventors: Anne-Julie MORNEAU-LEBEAU, Drummondville (CA); Maxime GERVAIS, Drummondville (CA)

(21) Appl. No.: 18/539,432

(22) Filed: Dec. 14, 2023

Related U.S. Application Data
(60) Provisional application No. 63/432,727, filed on Dec. 15, 2022.

(51) Int. Cl. F24F 12/00; F24F 7/10

(52) U.S. Cl. CPC F24F 12/001; F24F 7/10; F24F 2007/001

(57) ABSTRACT

A ventilation system having an energy recovery core having a plurality of energy recovery stages and a plurality of sets of stages spacers alternating with the plurality of energy recovery stages. Each energy recovery stage has upper and lower panels forming openings covered with an energy transfer sheet.

### PRIORITY

This application claims benefit under 35 U.S.C. § 119(e) to U.S. Provisional Application Ser. No. 63/432,727, filed Dec. 15, 2022, which is expressly incorporated by reference herein and made a part hereof.

### BACKGROUND

The present disclosure relates, generally, to a ventilation system for heat and/or energy recovery. More specifically, the present disclosure relates to a construction of an energy recovery core comprising a plurality of plates separated by plate spacers.

Additional features of the present disclosure will become apparent to those skilled in the art upon consideration of illustrative embodiments exemplifying certain modes of carrying out the disclosure as presently perceived.

### SUMMARY

A ventilation system having a housing defining an internal space and having a fresh-air inlet, a fresh-air outlet, an exhaust inlet, and an exhaust outlet; a blower configured to move air from the fresh-air inlet to the fresh-air outlet and/or from the exhaust inlet to the exhaust outlet; and an energy recovery core arranged in the internal space of the housing. The energy recovery core has a plurality of energy recovery stages and a plurality of stages spacers alternating with the plurality of energy recovery stages. In one embodiment, at least one energy recovery stage comprises and upper panel and a lower panel defining flow channels there between, and at least one of the upper panel and lower panel defines a plurality of openings therethrough. An energy transfer sheet optionally covers the plurality of openings. At least one energy recovery stage optionally comprises an upper panel and a lower panel defining flow channels there between, and the upper panel defining a plurality of openings therethrough and the lower panel defining a plurality of openings therethrough. A first energy transfer sheet optionally covers the plurality of openings in the upper panel and a second energy transfer sheet optionally covers the plurality of openings in the lower panel. Each set of the plurality of stage spacers may include a first stage spacer arranged along a perimeter edge of an adjacent energy recovery stage, a second stage spacer arranged along an opposite perimeter edge of the adjacent energy recovery stage, and a third stage spacer arranged between the first and second stage spacers. The plurality of stage spacers space apart two adjacent energy recovery stages to define airflow passages. The airflow passages defined by the plurality of stage spacers can be exhaust flow passages.

An energy recovery core for a ventilation system, the energy recovery core having a plurality of energy recovery stages and a plurality stage spacers alternating with the plurality of energy recovery stages. At least one energy recovery stage optionally comprises and upper panel and a lower panel defining flow channels there between, and at least one of the upper panel and lower panel defines a plurality of openings therethrough. An energy transfer sheet optionally covers the plurality of openings. In another embodiment, at least one energy recovery stage comprises and upper panel and a lower panel defining flow channels there between, and the upper panel defining a plurality of openings therethrough and the lower panel defining a plurality of openings therethrough. A first energy transfer sheet optionally covers the plurality of openings in the upper panel and a second energy transfer sheet optionally covers the plurality of openings in the lower panel. Each set of the plurality of stage spacers optionally includes a first stage spacer arranged along a perimeter edge of an adjacent energy recovery stage, a second stage spacer arranged along an opposite perimeter edge of the adjacent energy recovery stage, and a third stage spacer arranged between the first and second stage spacers. The plurality of stage spacers can space apart two adjacent energy recovery stages to define airflow passages. The airflow passages defined by the plurality of stage spacers can be exhaust flow passages.

An energy recovery core for a ventilation system, the energy recovery core having a plurality of energy recovery stages, wherein at least one energy recovery stage comprises an upper panel and a lower panel defining flow channels there between, wherein the upper panel defining a plurality of openings therethrough and the lower panel defining a plurality of openings therethrough; and a first energy transfer sheet covering the plurality of openings in the upper panel and a second energy transfer sheet covering the plurality of openings in the lower panel. A plurality of stage spacers optionally alternates with the plurality of energy recovery stages. The first energy transfer sheet optionally comprises a hydrophile coating. The second energy transfer sheet also optionally comprises a hydrophile coating.

### BRIEF DESCRIPTIONS OF THE DRAWINGS

The accompanying drawings, which are included to provide further understanding and are incorporated in and constitute a part of this specification, illustrate disclosed embodiments and together with the description serve to explain the principles of the disclosed embodiments. In the drawings:

FIG. 1 is a perspective view of one embodiment of the ventilation system of the present disclosure.

FIG. 2 is a perspective view of the energy recovery core of the ventilation system of FIG. 1.

FIG. 3 is an exploded perspective view of two stages and two sets of stage spacers of the energy recovery core of the ventilation system of FIG. 1.

FIG. 4A is an exploded exhaust side view of two stages and two sets of stage spacers of the energy recovery core of the ventilation system of FIG. 1.

FIG. 4B is an exploded supply side view of two stages and two sets of stage spacers of the energy recovery core of the ventilation system of FIG. 1.

FIG. 5A is a plane view of the two stages and sets of stage spacers shown in FIG. 3.

FIG. 5B is a plane view of an upper panel of one of the stages shown in FIG. 5A.

FIG. 6A is an exploded cross-sectional view of two stages and two sets of stage spacers of one embodiment of the energy recovery core of this disclosure showing hyrophile coatings of the energy recovery sheets both oriented in the same direction.

FIG. 6B is an exploded cross-sectional view of two stages and two sets of stage spacers of another embodiment of the energy recovery core of this disclosure showing the hyrophile coatings of the energy recovery sheets both oriented inward.

FIG. 6C is an exploded cross-sectional view of two stages and sets of stage spacers of another embodiment of the energy recovery core of this disclosure showing the hyrophile coatings of the energy recovery sheets both oriented outward.

FIG. 6D is a cross-sectional view of an exemplary energy transfer sheet.

FIG. 7A depicts a parallelogram shaped energy recovery core, consistent with this disclosure.

FIG. 7B depicts a diamond shaped energy recovery core, consistent with this disclosure.

FIG. 7C depicts a rectangular shaped energy recovery core, consistent with this disclosure.

FIG. 7D depicts a tilted diamond shaped energy recovery core, consistent with this disclosure.

FIG. 8 depicts an alternate configuration of the ventilation system of the present disclosure to allow airflow to be directed through the energy recovery core in different configurations.

FIG. 9 depicts another alternate configuration of the ventilation system of the present disclosure to allow airflow to be directed through the energy recovery core in different configurations.

FIG. 10 depicts an alternative arrangement of the stage spacers to form a non-linear flow passageway between the energy recovery stages.

FIG. 11 depicts another alternative arrangement of the stage spacers to form a non-linear flow passageway between the energy recovery stages.

### DETAILED DESCRIPTION

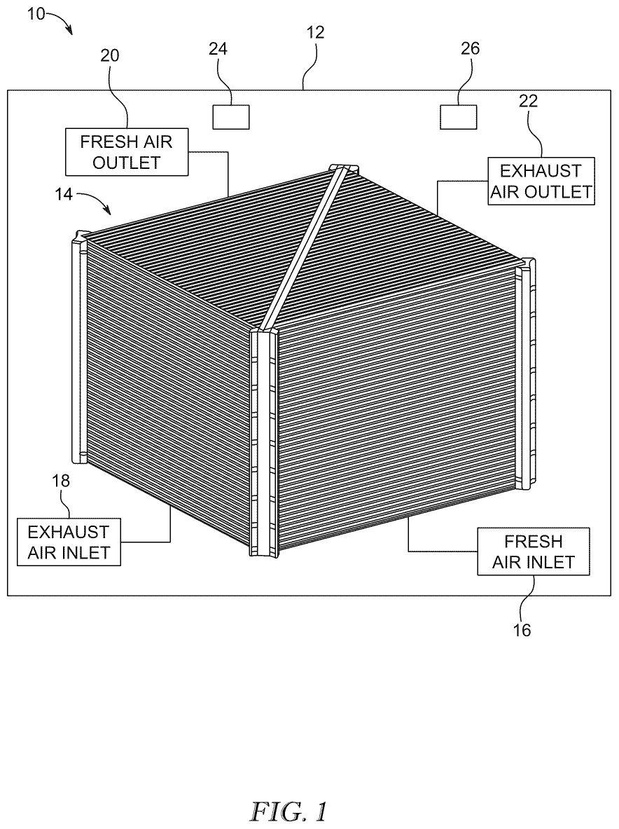

An embodiment of a ventilation system 10 in accordance with the present disclosure is shown in FIG. 1. The ventilation system 10 includes a housing 12 and an energy recovery core 14 arranged in the housing 12. A fresh air inlet 16, an exhaust air inlet 18, a fresh air outlet 20, and an exhaust air outlet 22 are defined in the housing 12 to allow passage of flows of exhaust air and fresh air through the ventilation system 10. The energy recovery core 14 is arranged between the inlets 16, 18 and outlets 20, 22 to transfer heat and/or humidity between the fresh air and exhaust air flowing through the ventilation system 10. A pair of blowers 24, 26 is configured to move air through the inlets 16, 18 and outlets 20, 22, although in some embodiments only one blower may be included. Some examples of energy recovery cores are described in U.S. Pat. No. 7,331,376, filed Dec. 19, 2003 and U.S. Patent Publication No. 2006/0096746, filed Oct. 10, 2005, each of which is expressly incorporated by reference herein in their entirety.

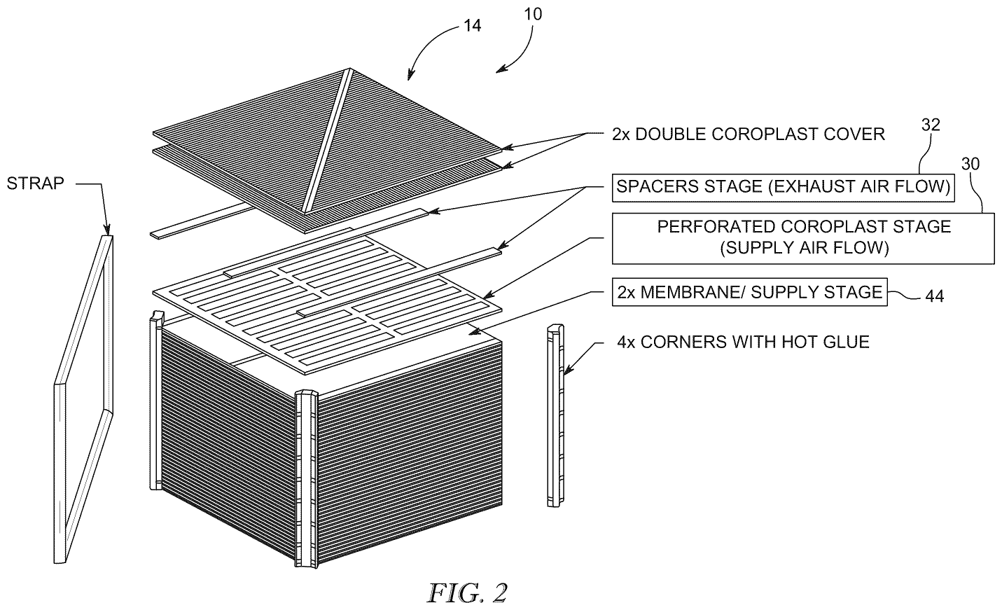

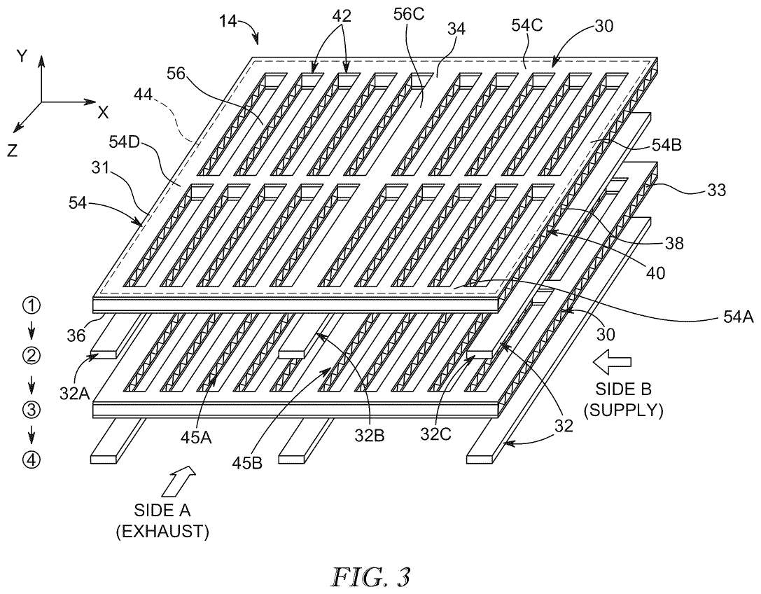

The energy recovery core 14 is comprised of a plurality of stacked energy recovery stages (sometimes referred to in the industry as a plate) 30 and a plurality of stage spacers 32 spacing the energy recovery stages 30 from one another, as shown in FIGS. 2 and 3. In the depicted embodiments, a plurality of stage spacers 32 is located between each pair of adjacent energy recover stages 30. These sets of stage spacers 32 space and, optionally, interconnect the two adjacent energy recovery stages 30.

Each of the energy recovery stages 30, in one exemplary embodiment, has an upper panel 34 and a lower panel 36 and a plurality of ribs 38 extending between the upper and lower panels 34, 36, as shown in FIG. 3, to define a plurality of flow passages 40 between the upper and lower panels 34, 36. The flow passages 40 allow air to flow from a first side of the energy recovery stage 30 to a second, opposing, side of the energy recovery stage 30 between the upper and lower panels 34, 36. In one example, the flow passages 40 allow air to flow from the fresh air inlet 16 toward to the fresh air outlet 20. In some embodiments, the energy recovery core 14 may be structured so that the flow passages 40 allow air to flow from the exhaust inlet 18 toward the exhaust outlet 22. In one embodiment, the upper and lower panels 34, 36 are comprised of a polymer such as coroplast. In other embodiments, aluminum and other appropriate materials are also contemplated. In one embodiment, the plurality of ribs 38 are provided by a corrugated sheet, which can similarly be comprised of a polymer (such as coroplast) aluminum, or other appropriate material.

Each of the plurality of stage spacers 32 in a set of stage spacers 32 between a pair of adjacent energy recovery stages 30 are spaced apart from one another as shown in FIG. 3. In the embodiment depicted in FIG. 3, the plurality of stage spacers 32 includes a first stage spacer 32A, a second stage spacer 32B, and a third stage spacer 32C. The first stage spacer 32A is arranged to lie along a first lateral edge 31 of the adjacent energy recovery stages near an inlet or outlet to the flow passages 40. The third stage spacer 32C is arranged to lie along an opposite second lateral edge 33 of the adjacent energy recovery stages near the other of the inlet or outlet of the flow passages 40. The second stage spacer 32B is arranged to lie in a generally central region of the adjacent energy recovery stages 30 and, in one exemplary embodiment, substantially equidistant from both the first and third stage spacers 32A, 32C.

By spacing two adjacent energy recovery stages 30, a first exhaust passageway 45A is defined between the first and second stages spacers 32A, 32B and a second exhaust passageway 45B is defined between the second and third stage spacers 32B, 32C. Each of the first and second exhaust passageway 45A, 45B is also located between the two adjacent energy recovery stages 30 and extends substantially perpendicular to the flow passages 40 defined between the upper and lower panels 34, 36 of the adjacent energy recovery stages 30. Each exhaust passageway 45A, 45B allows air to flow from the exhaust inlet 18 towards the exhaust outlet 22 between each of the adjacent energy recovery stages 30. In some embodiments, the energy recovery core 14 may be structured so that the exhaust passageways 45A, 45B provide air from the fresh air inlet 16 toward the fresh air outlet 20.

The upper and lower panels 34, 36 of each energy recovery stage 30 are perforated to define openings 42 that extend there through. One or more energy transfer sheets (e.g. membranes) 44 are applied on both the upper and lower panels 34, 36 to cover all of the openings 42. The energy transfer sheets 44 allow heat and/or moisture transfer from air traveling through the exhaust passageways 45A, 45B and into the air traveling through the flow passages 40 to allow recovery of that heat and/or moisture during operation of the ventilation system 10. The energy transfer sheets 44 may include any material or type available now or hereafter developed.

Each of the openings 42 formed in the upper and lower panels 34, 36 of the energy recovery stages 30 defines a length 50 and a width 52, which is less than the length 50. Each energy recovery stage 30 is oriented so that the length 50 of each opening 42 extends in a substantially parallel direction relative to one another. The openings 42 also extend in a substantially parallel direction relative to each of the stage spacers 32 and substantially perpendicular to the direction of flow of air through the flow passages 40. Orienting each of the energy recovery stages 30 and each of the stage spacers 32 in this manner increases the effective surface area of each energy transfer sheet 44 in the energy recovery core 14 as a whole thereby increasing an energy transfer efficiency of the ventilation system 10. Some other ventilation systems alternate the orientation of each stage by 90 degrees, for example, which results in a lower effective surface area and a corresponding lower efficiency.

In some embodiments, the length 50 of the openings 42 may be parallel with the flow passages 40. In this embodiment, the stage spacers 32 may also be parallel with the flow passages 40. In other embodiments, the stage spacers 32 are not parallel with the flow passages 40 or the openings 42. The openings 42 may have any shape in other embodiments.

In one embodiment, the openings 42 are defined all or in part by a perimeter frame 54 and/or a plurality of support beams 56 that extend between sides of the perimeter frame 54 as shown in FIGS. 3 and 5B. The perimeter frame 54 forms a quadrilateral shape, such as a square or rectangle, having first, second, third and fourth sides 54A, 54B, 54C, 54D. The plurality of support beams 56 are coupled to at least one of the first, second, third and fourth sides 54A, 54B, 54C, 54D end extend inwardly. Each opening 42 is defined by a combination of one or more of the first, second, third and fourth sides 54A, 54B, 54C, 54D and one or more support beams 56. Sides 54B and 54D are situated and formed to include the inlet and outlet, respectively, to the flow passages. Sides 54A and 54C are closed off by one of the ribs 38, for example. In other embodiments, the upper and lower panels 34, 36 are sheets with openings 42 defined therethrough in any known manner.

The first and third stage spacers 32A, 32C are each coupled to opposing sides 54B, 54D of the perimeter frame 54 as shown in FIGS. 3 and 5B. The second stage spacer 32B is coupled to a central support beam 56C included in the plurality of support beams 56. In the illustrative embodiment, the central support beam 56C extends all the way between sides 54A and 54C to provide a continuous contact surface for the second stage spacer 32B, in one exemplary embodiment. The central support beam 56C has a width that is greater than each of the other support beams 56.

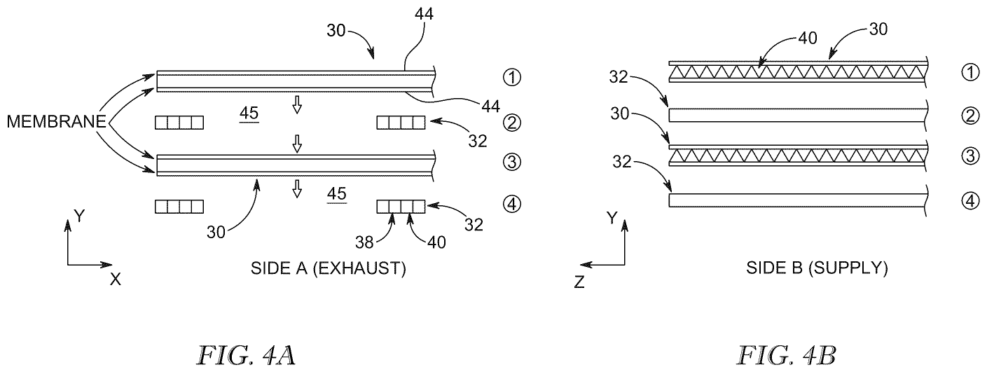

As shown in FIGS. 4A and 4B, the energy recovery core 14 alternates between a single energy recovery stage 30 and a single set of stage spacers 32 when they are stacked with one another. Openings 42 are defined in both the upper panel 34 and the lower panel 36 of each energy recovery stage 30 and are overlaid with an energy transfer sheet 44. Thus, each energy transfer sheet 44 is located directly between a single energy recovery stage 30 and a single set of stage spacers 32. Each energy transfer sheet 44 can be fixed to the adjacent upper or lower panel 34, 36 by a glue such as Latex glue, hot welding, or any other type of adhesive or lamination technique.

Each of the stage spacers 32 may include a strip of coroplast having a width that is less than the coroplast sheets forming each of the upper and lower panels 34, 36 of the energy recovery stages 30. In the illustrative embodiment each of the stage spacers 32 have a width that is less than 10 percent the width of the energy recovery stages 30. The coroplast strips forming the stage spacers 32 are substantially similar to the coroplast sheets forming the energy recovery stages 30 except that the coroplast strips are oriented 90 degrees relative to each energy recovery stage 30. Thus, flow passages 40 are also formed in each coroplast strip of the stage spacers 32 and extend in a direction that is substantially perpendicular to the flow passages 40 formed in each energy recovery stage 30. In some embodiments, coroplast strips may not be used to form each of the stage spacers 32 and the stage spacers 32 may be formed by an extruded polymeric material or any other.

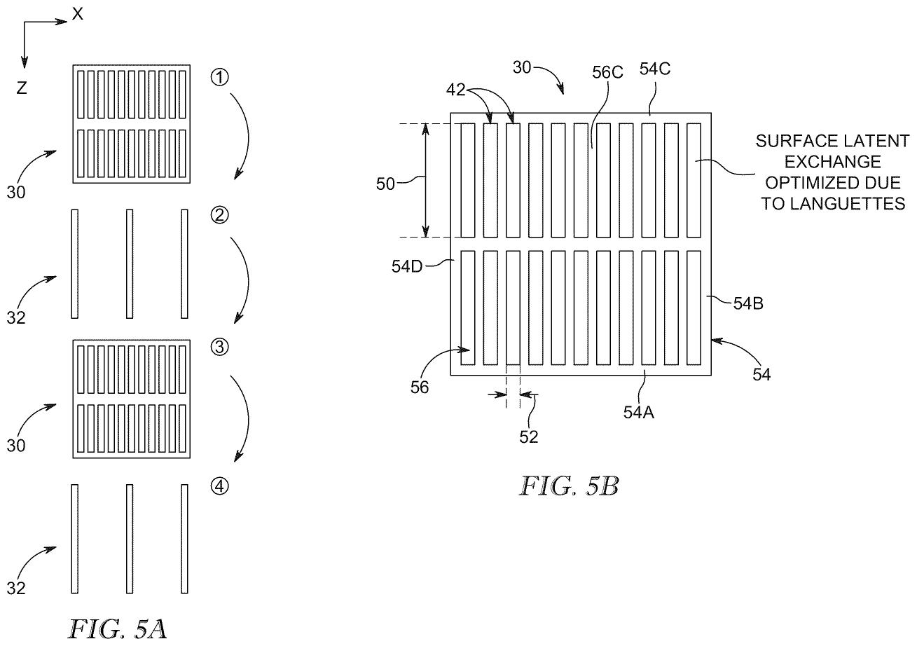

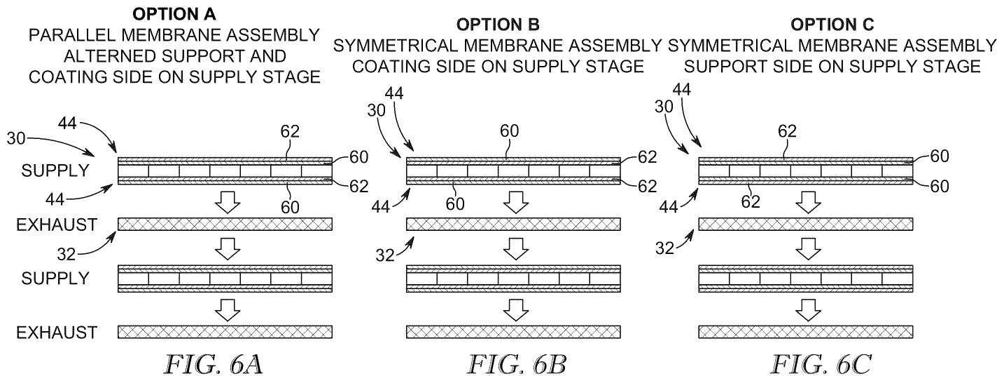

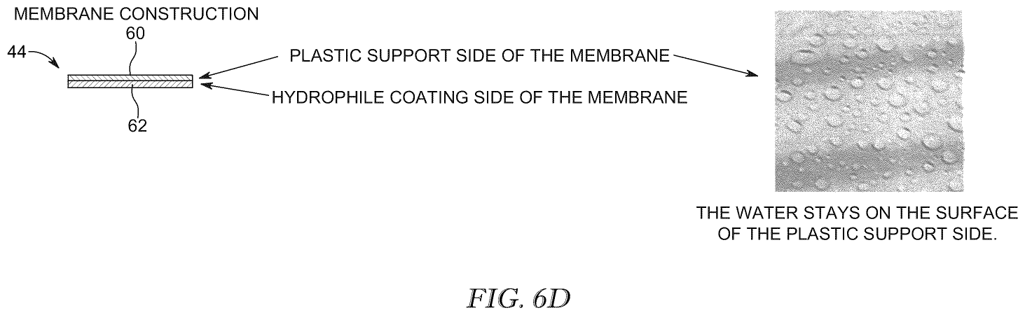

The energy transfer sheet(s) 44 may be applied to each of the upper and lower panels 34, 36 of each energy recovery stage 30 in variety of orientations as suggested in FIGS. 6A-6C. In one embodiment, each energy transfer sheet 44 includes a carrier sheet 60 and a hydrophile coating 62 applied to the carrier sheet 60. In some embodiments, each energy transfer sheet 44 is oriented in the same direction relative to a corresponding energy recovery stage 30. In this embodiment, the carrier sheet 60 of one of the energy transfer sheets 44 is fixed directly to the upper panel 34 while the hydrophile coating 62 of the other energy transfer sheet 44 is fixed directly to the lower panel 36 as shown in FIG. 6A.

In some embodiments, each energy transfer sheet 44 is oriented so as to be symmetrical relative to each corresponding energy recovery stage 30 as shown in FIG. 6B. In this situation, the carrier sheet 60 of each energy transfer sheet 44 is fixed directly to the upper and the lower panels 34, 36 of each corresponding energy recovery stage 30.

In some embodiments, each energy transfer sheet 44 is oriented in the opposite configuration shown in FIG. 6B. In this situation, the hydrophile coating 62 of each energy transfer sheet 44 is fixed directly to the upper and the lower panels 34, 36 of each corresponding energy recovery stage 30 as shown in FIG. 6C.

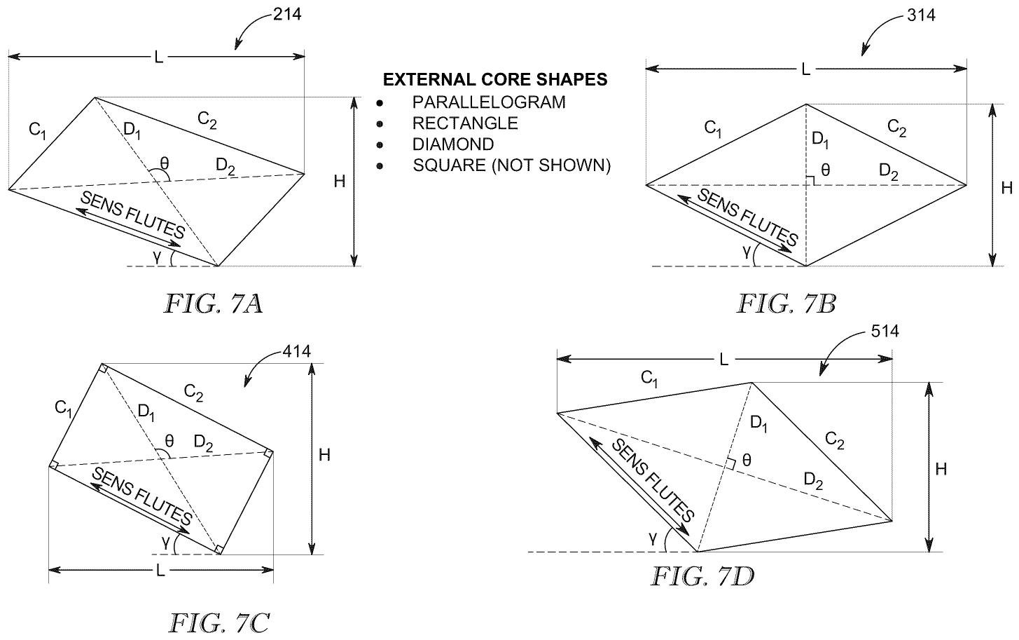

The arrangement of energy recovery stages 30 and stage spacers 32 may result in unequal flow rates through the flow passages 40 of the energy recovery stages 30 and the passageways 45A, 45B between the stage spacers 32. Accordingly, the energy recovery core 14 may be formed to include a shape other than a square or cube as shown in FIGS. 7A-7D. Altering the shape and/or orientation of the energy recovery core 14 can optimize at least one of energy transfer, flow rate, and pressure of the ventilation system 10.

FIG. 7A shows an energy recovery core 214 having a similar layup of stages 30 and spacers 32 to the energy recovery core 14 described above, but having a parallelogram shape. The parallelogram shape may result in one of the flow directions having a longer travel path through the energy recovery core 214 to optimize at least one of energy transfer, flow rate, and pressure.

FIG. 7B shows an energy recovery core 314 having a similar layup of stages 30 and spacers 32 to the energy recovery core 14 described above, but having a diamond shape. The diamond shape may result in flow paths through the energy recovery core 314 that are not perpendicular to one another to optimize at least one of energy transfer, flow rate, and pressure.

FIG. 7C shows an energy recovery core 414 having a similar layup of stages 30 and spacers 32 to the energy recovery core 14 described above, but having a rectangular shape. The rectangular shape may result in one of the flow directions having a longer travel path through the energy recovery core 314 to optimize at least one of energy transfer, flow rate, and pressure.

FIG. 7D shows an energy recovery core 514 having a similar layup of stages 30 and spacers 32 to the energy recovery core 14 described above, but having a diamond shape that is tilted to one side compared to FIG. 7B. The diamond shape and orientation may result in flow paths through the energy recovery core 514 that are not perpendicular to one another and varying incidence angles relative to the inlets 16, 18 to optimize at least one of energy transfer, flow rate, and pressure.

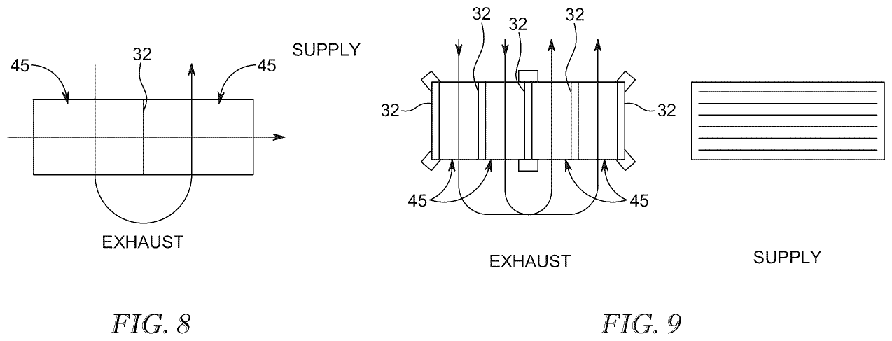

In some embodiments, one or both of the supply and exhaust flow paths through the energy recovery core 14, 214, 314, 414, 514 can be redirected to make multiple passes through all or a portion of the energy recovery core 14, 214, 314, 414, 514 before passing through one or both of the outlets 20, 22 as shown in FIGS. 8 and 9. For example, the energy recovery core 14, 214, 314, 414, 514 can be structured to cause the air to flow through a first passageway 45 and to make a U-turn to pass back through a second passageway 45 separate from the first passageway 45 around the second stage spacer 32B as shown in FIG. 8. In another embodiment, additional stage spacers 32 are included in one or more sets to provide additional passageways 45 and the energy recovery core 14, 214, 314, 414, 514 can be structured to cause the air to flow through a one passageway 45 and to make a U-turn to pass back through another passageway 45 as shown in FIG. 9.

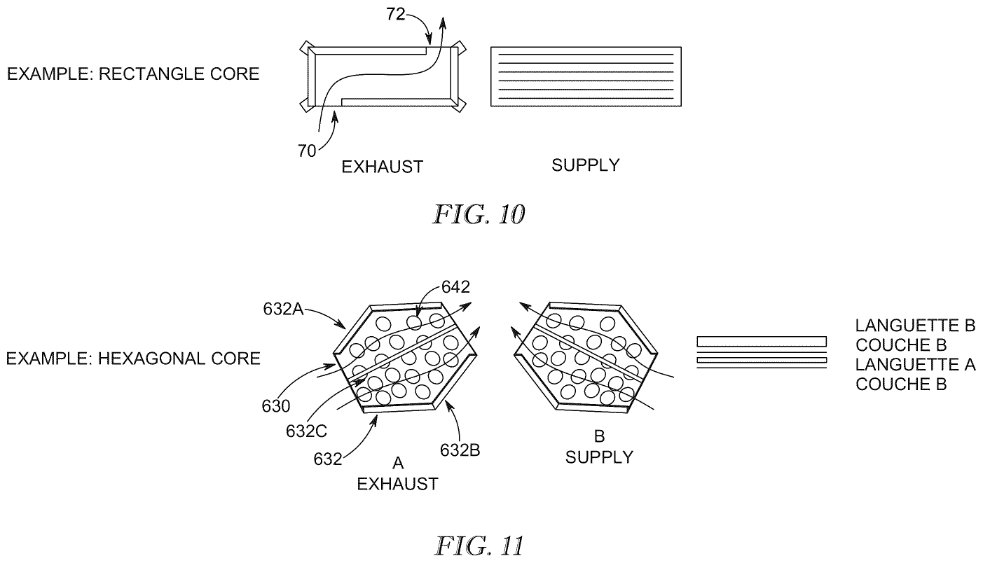

In some embodiments, the stage spacers 32 can be arranged and/or structured so that they form a non-linear flow passageway between the energy recovery stages as shown in FIGS. 10 and 11. Such embodiments may increase the residence time of the air within the energy recovery core to increase efficiencies. In one embodiment, the stage spacers 32 are arranged in two L-shaped arrangements to provide an inlet 70 at one corner of the energy recovery core 14, 214, 314, 414, 514 and an outlet 72 at another corner of the energy recovery core 14, 214, 314, 414, 514 that is offset from the inlet 70 as shown in FIG. 10.

In another embodiment, an energy recovery core 614 has a hexagonal shape with energy recovery stages 630 and stage spacers 632 as shown in FIG. 11. The energy recovery stages 630 are formed to include circular openings 642. The stage spacers 632 include a first bent spacer 632A, a second bent spacer 632B, and a straight spacer 632C between the first and second bent spacers 632A, 632B. In other embodiments, the openings 642 can have any suitable shape.

Headings and subheadings, if any, are used for convenience only and do not limit the invention. The word exemplary is used to mean serving as an example or illustration. To the extent that the term include, have, or the like is used, such term is intended to be inclusive in a manner similar to the term comprise as comprise is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

All numbers and ranges disclosed above may vary by some amount. Whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. In addition, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces. If there is any conflict in the usages of a word or term in this specification and one or more patent or other documents that may be incorporated herein by reference, the definitions that are consistent with this specification should be adopted.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

In one aspect, a term coupled or the like may refer to being directly coupled. In another aspect, a term coupled or the like may refer to being indirectly coupled. Terms such as top, bottom, front, rear, side, horizontal, vertical, and the like refer to an arbitrary frame of reference, rather than to the ordinary gravitational frame of reference. Thus, such a term may extend upwardly, downwardly, diagonally, or horizontally in a gravitational frame of reference.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the claimed subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately claimed subject matter.

The use of the terms “a” and “an” and “the” and “said” and similar references in the context of describing the invention (especially in the context of the following claims) are to be construed to cover both the singular and the plural, unless otherwise indicated herein or clearly contradicted by context. An element proceeded by “a,” “an,” “the,” or “said” does not, without further constraints, preclude the existence of additional same elements. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the disclosure and does not pose a limitation on the scope of the disclosure unless otherwise claimed. No language in the specification should be construed as indicating any non-claimed element as essential to the practice of the disclosure.

Numerous modifications to the present disclosure will be apparent to those skilled in the art in view of the foregoing description. Preferred embodiments of this disclosure are described herein, including the best mode known to the inventors for carrying out the disclosure. It should be understood that the illustrated embodiments are exemplary only, and should not be taken as limiting the scope of the disclosure.

We claim:

1. A ventilation system comprising:
a housing defining an internal space and having a fresh-air inlet, a fresh-air outlet, an exhaust inlet, and an exhaust outlet;
a blower configured to move air from the fresh-air inlet to the fresh-air outlet and/or from the exhaust inlet to the exhaust outlet; and
an energy recovery core arranged in the internal space of the housing, the energy recovery core comprising
a plurality of energy recovery stages; and
a plurality of stage spacers alternating with the plurality of energy recovery stages.

2. The ventilation system of claim 1, wherein at least one energy recovery stage comprises and upper panel and a lower panel defining flow channels there between, and at least one of the upper panel and lower panel defines a plurality of openings therethrough.

3. The ventilation system of claim 2, further comprising an energy transfer sheet covering the plurality of openings.

4. The ventilation system of claim 1, wherein at least one energy recovery stage comprises and upper panel and a lower panel defining flow channels there between, and the upper panel defining a plurality of openings therethrough and the lower panel defining a plurality of openings therethrough.

5. The ventilation system of claim 4, further comprising a first energy transfer sheet covering the plurality of openings in the upper panel and a second energy transfer sheet covering the plurality of openings in the lower panel.

6. The ventilation system of claim 1, wherein each set of the plurality of stage spacers includes a first stage spacer arranged along a perimeter edge of an adjacent energy recovery stage, a second stage spacer arranged along an opposite perimeter edge of the adjacent energy recovery stage, and a third stage spacer arranged between the first and second stage spacers.

7. The ventilation system of claim 6, wherein the plurality of stage spacers space apart two adjacent energy recovery stages to define airflow passages.

8. The ventilation system of claim 7, wherein the airflow passages defined by the plurality of stage spacers are exhaust flow passages.

9. An energy recovery core for a ventilation system, the energy recovery core comprising:
a plurality of energy recovery stages; and
a plurality stage spacers alternating with the plurality of energy recovery stages.

10. The energy recovery core of claim 9, wherein at least one energy recovery stage comprises and upper panel and a lower panel defining flow channels there between, and at least one of the upper panel and lower panel defines a plurality of openings therethrough.

11. The energy recovery core of claim 10, further comprising an energy transfer sheet covering the plurality of openings.

12. The energy recovery core of claim 9, wherein at least one energy recovery stage comprises and upper panel and a lower panel defining flow channels there between, and the upper panel defining a plurality of openings therethrough and the lower panel defining a plurality of openings therethrough.

13. The energy recovery core of claim 12, further comprising a first energy transfer sheet covering the plurality of openings in the upper panel and a second energy transfer sheet covering the plurality of openings in the lower panel.

14. The energy recovery core of claim 9, wherein each set of the plurality of stage spacers includes a first stage spacer arranged along a perimeter edge of an adjacent energy recovery stage, a second stage spacer arranged along an opposite perimeter edge of the adjacent energy recovery stage, and a third stage spacer arranged between the first and second stage spacers.

15. The energy recovery core of claim 14, wherein the plurality of stage spacers space apart two adjacent energy recovery stages to define airflow passages.

16. The energy recovery core of claim 15, wherein the airflow passages defined by the plurality of stage spacers are exhaust flow passages.

17. An energy recovery core for a ventilation system, the energy recovery core comprising:
a plurality of energy recovery stages, wherein at least one energy recovery stage comprises
an upper panel and a lower panel defining flow channels there between, wherein the upper panel defining a plurality of openings therethrough and the lower panel defining a plurality of openings therethrough; and
a first energy transfer sheet covering the plurality of openings in the upper panel and
a second energy transfer sheet covering the plurality of openings in the lower panel.

18. The energy recovery core of claim 17, further comprising a plurality stage spacers alternating with the plurality of energy recovery stages.

19. The energy recovery core of claim 17, wherein the first energy transfer sheet comprises a hydrophile coating.

20. The energy recovery core of claim 19, wherein the second energy transfer sheet comprises a hydrophile coating.
